(19) United States
(12) Patent Application Publication
(10) Pub. No.: US 2010/0167950 A1
(43) Pub. Date: Jul. 1, 2010

(54) MICROARRAY CHIP AND METHOD OF FABRICATING FOR THE SAME

(75) Inventors: Jyh-Lyh Juang, Miaoli County (TW); Yi-You Huang, Taipei City (TW); Po-Cheng Chen, Taipei City (TW)

Correspondence Address: ALSTON & BIRD LLP, BANK OF AMERICA PLAZA, 101 SOUTH TRYON STREET, SUITE 4000, CHARLOTTE, NC, 28280-4000, US

(73) Assignee: National Health Research Institute, Zhunan Town (TW)

(21) Appl. No.: 12/649,993

(22) Filed: Dec. 30, 2009

Related U.S. Application Data
(60) Provisional application No. 61/141,796, filed on Dec. 31, 2008.

(51) Int. Cl. C40B 30/04; C40B 40/00; C40B 60/12

(52) U.S. Cl. 506/9; 506/13; 506/39

(57) ABSTRACT

The present invention provides a microarray chip for use in the analysis of various sample types. The microarray chips disclosed herein generally comprise a substrate covered with a coating material comprising a photoresist material, wherein the coating material is patterned to comprise a plurality of microstructures such as microwells and/or microcolumns. Methods for preparing and utilizing the microarray chips of the invention are further provided. The microarray chips of the instant invention find particular use in high-throughput assays.

### CROSS-REFERENCE TO RELATED APPLICATIONS

This application claims the benefit of U.S. Provisional Application No. 61/141,796, filed Dec. 31, 2008, which is hereby incorporated herein in its entirety by reference.

### BACKGROUND OF THE INVENTION

The present invention relates to the fields of inorganic chemistry, organic chemistry, molecular biology, cellular biology, biochemistry and medicine. More particularly, the instant application discloses a microarray chip for analyzing a sample and method of fabricating for such microarray chips.

Cell-based assays have long been used in cell research to understand basic mechanisms of cellular fate and function. Automated multiwell formats are one of the most widely used high-throughput screening systems. The current trend in plate-based screening systems is to reduce the volume of the reaction wells further, thereby increasing the density of the wells per plate. The reduction in reaction volumes results in increased throughput, dramatically decreased bioreagent costs, and a decrease in the number of plates which need to be managed by automation. Over the last decade, microtechnology tools have emerged to probe biomedical phenomena at relevant length scales and to miniaturize and parallelize biomedical assays.

In a microarray-driven gene expression system developed for functional analysis of many gene products in parallel, cells may be cultured on a glass slide that is printed in defined locations with different DNAs. The cells that grow on the printed areas then take up the DNAs and create cell clusters of localized transfection within a lawn of non-transfected cells. The cell clusters can be screened for any property detectable on a surface and the identity of the responsible DNAs determined from the coordinates of the cell cluster with a phenotype of interest.

Typically, investigators have used Micro-Electro-Machining System (MEMS) fabrication process to form platforms for culturing cells and for dynamic monitoring of cell proliferation. A single cell microarray system has been described to analyze cellular response of individual cells. The single chip was made from polystyrene with microchambers to accommodate the cells. See Yomamura et al. (2005) Anal. Chem. 77: 8050-8056. Microwells of microarray systems have been fabricated from, for example, agarose, acrylamide, and polydimethylsiloxane (PDMS) to confine and control the cells and their growth on the surface of substrate. See Khetani et al. (2008) Nature Biotech. 26: 120-126. Conventional methods for fabricating microarray systems have involved, for example, preparing a porous substrate to increase the surface area of a microarray, and consequently the throughput capacity and sensitivity, wherein the pores serve as sites for attachment of one or more biomolecules.

In a recent development in the field of high throughput microarray system, resist materials such as SU-8 photoreist films have been used to construct microwells on a glass slide. See Chin et al. (2004) Biotechnology and Bioengineering 88 (3): 399-415. The resist material currently used in the preparation of microarray systems, however, exhibits poor adhesion to a glass surface. As a result, the resist material may peel off from a glass slide when the slide is immersed in the cell culture medium, and therefore, the cell-based assay conducted using such a microarray system may not provide reliable experimental results.

Accordingly, there is a need in the art for systematic cell-based assays in a high throughput screening format to analyze, for example, the phenotypic changes of exposing cells to biomolecules of interest. In particular, a microarray having a plurality of microwells or microcolumns constructed on a substrate that exhibits minimal or no peel-off the resist material coating the substrate is needed. Methods of fabricating such microarray systems are also desirable.

### BRIEF SUMMARY OF THE INVENTION

The present invention is directed to a microarray for use in the analysis of a sample and methods for preparing such microarrays. In particular aspects of the invention, the microarrays comprise a substrate covered with a coating material such as a commercially available photoresist film that has been patterned to form a plurality of microstructures on the substrate. The microarrays of the invention find particular use in high-throughput screening assays.

Methods for preparing the microarrays of the invention are further provided. In one embodiment, the method comprises providing a substrate, covering the substrate with a commercially available photoresist material, and patterning the photoresist material to produce a plurality of microstructures on the substrate. Methods of utilizing the disclosed microarrays for analysis of a variety of samples are further provided.

One aspect of the present invention provides a method for fabricating microarray chip which includes providing a substrate, forming a coating material comprising at least one of commercially available NANO™ SU-8 2-15, NANO™ SU-8 50-100, NANO™ SU-8 2000 series photoresist, NANO™ SU-8 3000 series photoresist and KMPR® 1000 series photoresist films on the substrate; and patterning the coating material in such a way that a plurality of microstructures are formed on a surface of the substrate.

Another aspect of the present invention provides a method of preparing a substrate for use in a high throughput microarray. The method includes covering a surface of the substrate with a coating material comprising at least one of commercially available NANO™ SU-8 2-15, NANO™ SU-8 50-100, NANO™ SU-8 2000 series photoresist, NANO™ SU-8 3000 series photoresist and KMPR® 1000 series photoresist films and patterning the coating material. The coating material is patterned to define a plurality of microwells arranged in spatially discrete regions on the surface the substrate so as to ensure each sample stayed within the individual well even if the substrate is immersed in the cell culture medium. In accordance with one example, the coating material may also be patterned to define a plurality of microcolumns arranged in spatially discrete regions on another surface the substrate so as to allow dispensing of the detecting molecules and/or therapeutic compounds into the plurality of microwells or similar structures holding the sample via the plurality of microcolumns.

One other aspect of the present invention provides a microarray chip which includes a quartz substrate and a patterned photoresist comprising at least one of commercially available NANO™ SU-8 2-15, NANO™ SU-8 50-100, NANO™ SU-8 2000 series photoresist, NANO™ SU-8 3000 series photoresist and KMPR® 1000 series photoresist films on a surface of the quartz substrate. The patterned photoresist defines a plurality of microwells on the quartz substrate.

And yet another aspect of the present invention provides a microarray chip which includes a glass substrate and a patterned photoresist comprising at least one of commercially available NANO™ SU-8 3000 series photoresist and KMPR® 1000 series photoreist films on a surface of the glass substrate. The patterned photoresist defines a plurality of microwells on the glass substrate.

And one other aspect of the present invention provides an array chip which includes a substrate and a patterned photoresist comprising at least one of commercially available NANO™ SU-8 2-15, NANO™ SU-8 50-100, NANO™ SU-8 2000 series photoresist, NANO™ SU-8 3000 series photoresist and KMPR® 1000 series photoresist films on a surface of the silicon substrate. The patterned photoresist defines a plurality of microcolumns on the silicon substrate. As another example, the substrate may include thereon a plurality of microcolumns made of micromachinined structures or similar structures made from microelectromechanical systems (MEMS) fabrication.

According to a further aspect of the present invention, a microarray analysis of a sample is conducted using the microarray chip. The microarray analysis includes preparing a microarray chip comprising a substrate, a patterned photoresist with a plurality of microwells defined on the substrate, wherein the patterned photoresist comprises at least one of commercially available NANO™ SU-8 2-15, NANO™ SU-8 50-100, NANO™ SU-8 2000 series photoresist, NANO™ SU-8 3000 series photoresist and KMPR® 1000 series photoresist films. In other example, the analysis may also include use of the microarray chip having a patterned photoresist with a plurality of microcolumns defined on the substrate, wherein the patterned photoresist comprises at least one of commercially available NANO™ SU-8 2-15, NANO™ SU-8 50-100, NANO™ SU-8 2000 series photoresist, NANO™ SU-8 3000 series photoresist and KMPR® 1000 series photoresist films. In other example, the microcolumns may include micromachinined structures or similar structures made from MEMS fabrication or nanotechnology. The sample may be dispensed in the microwells via the microcolumns, and components of the sample are allowed to bind to at least one biomolecule contained within the microwells. In addition, the at least one biomolecule may be dispensed from the microcolumns into the microwells holding the sample so as to ensure the sample binding to the at least one biomolecule. The microanalysis also includes detecting any binding to the biomolecule and a phenotypic consequence of the binding.

According to one other aspect of the present invention, a platform for analyzing binding of a probe to a sample is provided. The platform comprises an array chip comprising at least one substrate and a coating material covering the substrate, wherein the coating material comprises at least one commercially available photoresist material and is patterned to comprise a plurality of microwells; a means for applying the probe to the sample in the microwells; and a means for detecting any binding of the probe and the sample and any phenotypic change resulting from binding of the probe and the sample.

According to another aspect of the present invention, a drug screening method which includes preparing a microarray chip having a plurality of microwells defined on a substrate, wherein the microwells comprises microwells in at least one of commercially available NANO™ SU-8 2-15, NANO™ SU-8 50-100, NANO™ SU-8 2000 series photoresist, NANO™ SU-8 3000 series photoresist and KMPR® 1000 series photoresist films, culturing a target cell in the microwells, dispensing a candidate drug into the microwells, and detecting any binding of the candidate drug to the target cell and phenotypic change of the binding is provided. In another example, the microwells may be coated with the candidate drug before plating the target cells in the microwells. According to one further example, the candidate drug may be dispensed from an array chip having a substrate defined with a plurality of microcolumns, wherein the microcolumns comprise microcolumns in at least one of commercially available NANO™ SU-8 2-15, NANO™ SU-8 50-100, NANO™ SU-8 2000 series photoresist, NANO™ SU-8 3000 series photoresist and KMPR® 1000 series photoresist films. In addition, the microcolumns may also include micromachinined structures or similar structures made from MEMS fabrication.

According to yet another aspect of the present invention, an bioassay platform having a surface disposed with a plurality of microstructures comprising at least one of commercially available NANO™ SU-8 2-15, NANO™ SU-8 50-100, NANO™ SU-8 2000 series photoresist, NANO™ SU-8 3000 series photoresist and KMPR® 1000 series photoresist films is provided.

Additional objects and advantages of the invention will be set forth in part in the description which follows, and in part will be apparent from the description, or can be learned by practice of the invention. The objects and advantages of the invention will be realized and attained by means of the elements and combinations particularly pointed out in the appended claims.

It is to be understood that both the foregoing general description and the following detailed description are exemplary and explanatory only and are not restrictive of the invention, as claimed.

### BRIEF DESCRIPTION OF THE SEVERAL VIEWS OF THE DRAWING(S)

The foregoing summary, as well as the following detailed description of the invention, will be better understood when read in conjunction with the appended drawings. For the purpose of illustrating the invention, there are shown in the drawings embodiments which are presently preferred. It should be understood, however, that the invention is not limited to the precise arrangements and instrumentalities shown.

In the drawings:

FIG. 1 is a scanning electron microscopic image of the microarray chip according to one example of the invention;

FIG. 2 shows phase contrast microscopic images of HeLa cells cultured in a 2592-well chip with different magnifications (40× and 100×) according to another example of the invention;

FIG. 3 shows fluorescent microscopic images of HeLa cells cultured in a 2592-well chip with different magnifications (40× and 100×) according to another example of the invention;

FIG. 4 is a microscopic image of HeLa cells cultured in a 40098-well chip according to another example of the invention;

FIG. 5A is a phase contrast microscopic image of 293T cells in a 40098-well chip according to another example of the invention

FIG. 5B is a fluorescent microscopic image of 293T cells in a 40098-well chip according to another example of the invention

FIG. 6A is a phase contrast microscopic image of HeLa cells transfected with siGLO green transfection indicator in a 2592-well chip according to another example of the invention;

FIG. 6B is a fluorescent microscopic image of HeLa cells transfected with siGLO green transfection indicator in a 2592-well chip according to another example of the invention;

FIG. 7A is a fluorescent microscopic image of subcellular localization of NF-κB when HeLa cells were pretreated with 0.1 mM PDTC;

FIG. 7B is a fluorescent microscopic image of cell nuclei from the same group of the cells in FIG. 7A;

FIG. 7C is a fluorescent microscopic image of subcellular localization of NF-κB of non-treated HeLa cells;

FIG. 7D is a fluorescent microscopic image of cell nuclei from the same group of the cells in FIG. 7C;

FIG. 7E is a fluorescent microscopic image of subcellular localization of NF-κB when HeLa cells were pretreated with 0.2 mM LY294002; and

FIG. 7F is a fluorescent microscopic image of cell nuclei from the same group of the cells shown in FIG. 7E.

### DETAILED DESCRIPTION OF THE INVENTION

The present invention provides a microarray, more particularly a microarray comprising multiple microwells for sample analysis. Methods for preparing the microarrays of the invention are further provided. The microarrays of the instant invention find particular use in high-throughput assays.

The term “microarray” or “microarray chip” or “microarray system” as used herein refers to an analytical device comprising an ordered arrangement of compounds and serves as a medium for matching samples to the compounds based on complementarity and/or selective reaction and/or selective interaction. Microarrays generally comprise array elements in which the matching takes place. The microarrays of the present invention generally comprise a substrate coated with a patterned photoresist material. The term “microarray” is known and understood in the art.

The term “substrate” as used herein refers to a material or group of materials having a rigid or semi-rigid surface or surfaces. In many embodiments, at least one surface of the substrate will be substantially flat. In other aspects of the invention, it may be desirable to physically separate synthesis regions for different compounds with, for example, wells, raised regions, pins, etched trenches, or the like. A substrate of the invention may comprise any of a variety of organic or inorganic materials or combinations thereof, including but not limited to, plastics (e.g., polypropylene or polystyrene), ceramic, silicon, silica, glass, or quartz. In particular embodiments, the substrate is quartz. The substrates may have a thickness of, for example, a glass microscope slide, or a glass cover slip. Substrates that are transparent to light may be of particular useful for performing an assay that involves optical detection. However, non optical detection may be necessary for analysis which is performed using an array with a non-transparent substrate.

The term “spatially discrete region”, as used herein refers to an area on a substrate that is distinct or separate from another area on the substrate. For example, in the case of a plurality of microwells that are arranged in spatially discrete regions, each microwell occupies a specific area on the substrate. The specific areas may be distributed on the substrate in, for example, a random or uniform distribution.

As used herein, the term “sample” refers to, for example, a naturally occurring or synthetically produced nucleic acid, a polypeptide, an antibody, a cell, a microbe, a virus, an organelle, a cellular structure or a compound or small molecule of natural that is to be analyzed, for example, for a phenotypic change. The sample is complementary to, for example, a nucleic acid, a polypeptide or other compound of natural or synthetic origin that serves as a probe. In one embodiment, the sample may be a polypeptide with a known or unknown amino acid sequence having a known biological activity and the probe is an organic molecule, wherein after binding of the probe to the sample (i.e., the polypeptide), the biological activity is monitored to detect an increase or decrease in the biological activity of the bound polypeptide relative to that of the native, unbound polypeptide. Non-limiting examples of samples of the present invention include but are not limited to inorganic compounds (e.g., inorganic metals or salts), organic molecules (e.g., dyes, drugs, amino acids, small ligands, and synthetic organic compounds), biomolecules (e.g., DNA, RNA, PNA (i.e., protein nucleic acid), proteins, carbohydrates, amino acids, antibodies, cells, microbes, viruses and organelles. The sample may be obtained, for example, from a cell of a living or deceased organism, from an artificial cell culture, or from a natural source in a fresh, boiled or frozen state.

As used herein, the term “phenotypic change” includes but is not limited to a biological, cellular, chemical, physiological or physical change that occurs as a result of a sample or a part of the sample binding to a probe or binding of a candidate drug and a target cell in the microarray. Examples of the cellular change include but are not limited to changes in cell morphology, cell survival, apoptosis, cell migration, specific organelle, protein subcellular localization, protein level, enzyme activity, nucleotide level, nucleotide subcellular localization.

The present invention provides a microarray (e.g, a microarray chip) and a method for fabricating such a microarray chip for analyzing a sample. In one embodiment, the method of fabricating a microarray chip comprises providing a substrate, covering the substrate with a coating material comprising at least one of commercially photoresist material (e.g., film), and patterning the coating material in such a way that a plurality of microstructures are formed on the substrate. Exemplary commercially available photoresist films include but are not limited to the NANO™ SU-8 2000 series photoresist films (e.g., NANO™ SU-8 2000.5-2015, NANO™ SU-8 2025-2075, NANO™ SU-8 2100-2150, NANO™ SU-8 2-15, NANO™ SU-8 50-100), the NANO™ SU-8 3000 series photoresist films (e.g., NANO™ SU-8 3005-3010, NANO™ SU-8 3025-3035, NANO™ SU-8 3050), and KMPR® 1000 series photoresist films (e.g., KMPR® 1005-1010 and KMPR® 1025-1050). The invention is not intended to be limited to the photoresist films set forth above, and any photoresist or light sensitive materials sharing similar characterstics shall be encompassed by the present invention.

Microstructures are structural elements that ensure that first molecules that are immobilized on the surface of the substrate selectively bind to second molecules that are in volumes of sample. In general, the shape of the microstructure includes but is not limited to a well (e.g. microwell), a depression, a recess, a hole, a groove, a cavity, a pit, a pore, a trench, a channel, a concaved region, a channel-connected well, and other similar shapes known to those skilled in the art on the substrate. In the design of the drug array, the shape of the microstructures also includes but is not limited to a column (e.g. microcolumn), a protrusion, a post, a hump, a hill, a ridge, a bump, a bulge, a prominence, a projection, a convex region, and other similar shapes known to those skilled in the art on the substrate. In accordance with one specific example, the microstructures may be a plurality of microwells defined on a surface of the substrate to contain or hold the molecules in the volumes of sample. In accordance with another example, the microstructures may be a plurality of microcolumns defined on a surface of the substrate to provide areas for applying, diffusing, dispensing or discharging the probes, drugs or test compounds into the volumes of the sample. In accordance with a further example, the microstructures may include a plurality of microwells on one surface of the substrate to be associated with a plurality of corresponding microcolumns on another surface of the substrate.

The microstructures of the microarrays of the invention may be prepared by “patterning”. The patterning may comprise photolithographic exposure and development. In another embodiment, the patterning may comprise embossing the coating material. Prior to patterning, the wafer may be subjected to a wafer cleaning procedure which includes but is not limited to removal of the organic contaminants from the wafer in an organic clean step, removal of thin oxide layer from the wafer in an oxide strip step and removal of ionic contamination from the wafer in an ionic clean step. The wafer is then deposited with the coating material by methods known to those skilled in the art. In a specific example, the coating material is deposited on the surface by a spin-coating process. The coating material may be soft baked over a hot plate before the photolithographic exposure. During the photolithographic exposure, a light source of appropriate wavelength is used to transfer a geometric pattern containing an image of desired microstructures from a photomask to the coating material.

There may be both positive and negative tone photoresists used in the photolithographic process. For positive resists, the resist is exposed with UV light wherever the underlying material is to be removed. In these resists, exposure to the UV light changes the chemical structure of the resist so that it becomes more soluble in the developer. The exposed resist is then washed away by the developer solution, leaving windows of the bare underlying material. Therefore, the mask contains an exact copy of the pattern which is to remain on the wafer. Negative resists behave in just the opposite manner. Exposure to the UV light causes the negative resist to become polymerized, and more difficult to dissolve. Therefore, the negative resist remains on the surface wherever it is exposed, and the developer solution removes only the unexposed portions. Masks used for negative photoresists, therefore, contain the inverse (or photographic “negative”) of the pattern to be transferred.

After the exposure, the coating material may be soft baked again over the hot plate before developed using a developer. Once the patterned coating material is developed, it is rinsed, dried and hard baked in a conventional oven. It is noted that the invention is not limited to the patterning steps described above, other patterning techniques known to those skilled in art to achieve the similar patterning results are encompassed by the instant invention. And the microcolumns described throughout the invention are not limited to those made from photoresist materials. It may also be desirable within the scope of the invention to manufacture the microcolumns using other polymers according to well known micromachined or MEMS fabrication processes. For example, three dimensional microstructures, such as microcolumns may be fabricated in optical gain medium using two photon induced photopolymerization technique described by Yokoyama et al. (2003) Thin Solid Films (438-439): 452-456 and Mendonca et al. (2008) Applied Physics A (90): 633-636. In the photopolymerization process, femtosecond pulse laser may be used to machine any kind of material such as a metal, dielectric, semiconductor, or polymer. The processing is driven by a multiphoton absorption of energy from the pulse laser, resulting in the breaking of all bonds and the atomizing of materials. This laser processing is also capable of very high spatial resolution with the highest precision in the range of hundreds of nanometers. In the polymerization process, a photochemical reaction is initiated through a radical mechanism following two photon excitation of a photoinitiator. The photo-reactive resins that are most commonly used are acylate monomers or acrylic pre-polymers, which can be made to cross-link with the use of a radical photoinitiator molecule.

In another embodiment of the present invention, a method of detecting an analyte is provided comprising applying a sample to a microarray, binding the sample to at least one probe molecule, and detecting any binding to the sample, wherein the binding indicates the presence of the analyte in the sample. In one embodiment, an automated spotting device is utilized, e.g. Perkin Elmer Biochip Arrayer™ for applying the sample to the microarray. A number of contact and non-contact microarray printers are available and may be used to print the binding members on a substrate. For example, non-contact printers are available from Perkin Elmer (BioChip Arrauer™), Labcyte and IMTEK (TopSpot™). These devices utilize various approaches to non-contact spotting, including piezo electric dispension; touchless acoustic transfer; en bloc printing from multiple microchannels; and the like. Other approaches include ink jet-based printing and microfluidic platforms. Contact printers are commercially available from TeleChem International (ArrayIt™).

Non-contact printing may be adopted for the production of high-specificity cellular microarrays. With a non-contact printer, no solid printer part contacts the array surface. By utilizing a printer that does not physically contact the surface of the substrate, no aberrations or deformities are introduced onto the substrate surface, thereby preventing uneven or aberrant cellular capture at the site of spotted probe. Such printing methods find particular use with high specificity hydrogel substrates.

By printing onto the surfaces of multi-well plates, one can combine the advantages of the array approach with those of the multi well approach. Since the separation between tips in the microarrayers can be custom-made to be compatible with the multi well plate, one can simultaneously print each load in several microwells. Printing into microwells can be done using both contact and non-contact technology, where the latter is also compatible with non-flat multi-well plates. The surface of the microwells in the multi-well plate may be functionalized and/or coated so as to make them more compatible with specific cell-array applications. Surface materials can also include nanotubes, modified or coated to allow binding of a capture probe. Surfaces which otherwise are not repellent of cells enough to adequately reduce background binding may also be used in association with a repellent coating, or an electric or magnetic field which weakly repulses cells from the array surface.

Besides the pin printing technology adopted in the fabrication of array, there are other fabrication/spotting methods, such as microfluidic or continuous-flow micro-spotting technology. See Eddings et al. (2008) Analytical Biochemistry 382 (3): 55-59. In a 2-D microfluidic systems, isolated flow cells deposit biomolecules to specific miniature regions of the surface. More recent microfluidic attempts have focused on 3-D microfluidic networks to confine deposition to specific locations on the substrate to minimize sample depletion and increase reaction zone density. For example, a 3-D continuous flow microspotter may be used to deposit the sample within the individual flow cells, which eliminates sample cross-over.

A dilution series of biomolecule of interest will provide information regarding avidity of the interaction of biomolecule and its target on the cells. When the affinity of the interaction is known, the binding to a dilution series can be used to obtain an absolute measure for the expression level of the target that interacts with the biomolecule. Alternatively, a relative measure of the expression levels can be obtained without the need for additional kinetic information by using a differential profiling experiment where two or more, differentially labeled cell populations compete on the binding to the same spots.

Within certain ranges of cells and binding members, the number of captured cells will be proportional to the expression level of the cognate protein, the affinity of the interaction, and the number of cells in the population capable of being captured and the exposure rate of cells to a particular geographic region. A dilution series may be used in the isolation of cells based on the expression level of the ligand for the biomolecule. Cells expressing higher levels of the ligand will bind to spots comprising lower level of the biomolecule. Spots with lower levels of capture probe can be used to enrich cells expressing higher levels of cell surface target. A dilution series can also be used for studying binding curves and phenotypic studies of cells that are sub-fractionated by the spots and/or for studying dose-dependent effects of effector biomolecule, etc.

In other aspects of the invention, the binding may produce a phenotypic change such as, for example, a change in cell morphology, cell survival, apoptosis, cell migration, specific organelle, protein subcellular localization, protein level, enzyme production, enzyme activity, nucleotide level, nucleotide subcellular localization. A probe of the invention may be labeled with a detectable substance such as, for example, a fluorescent molecule, a chemiluminescent fragment, or a radioactive molecule. The step of detecting may comprise detecting a fluorescent signal, light scattering, a radioactive signal, an optical signal, an electronic signal, or mass desorption. The step of detecting may comprise electronic discrimination which includes determining a change in mass, capacitance, resistance, inductance or a combination thereof as compared to a control. The analyte may be selected from the group consisting of small organic molecules, a biomolecule, a macromolecule, a particle and a cell.

The present invention also provides an analysis of samples using the microarray chip to identify and quantify analyte molecules. In addition to the microarray chip, many instruments, materials, pipettors, robotics, plate washers and plate readers are commercially available to fit the multi-well format to a wide range of homogenous and heterogenous assays. The method of analysis includes identifying, detecting, determining, measuring, or screening for a compound of interest. The method includes delivering the sample to the microstructures, such as microwells on the microarray chip of the present invention, washing the microwells to remove unbound sample, and detecting, either directly or indirectly, the presence, absence or a specific amount of analyte retained in the microwells. In a specific embodiment, the analysis process involves a binding or hybridizing step in which a molecule that is immobilized on the surface of the substrate selectively binds to a molecule that is in the volume of sample.

In particular assays based upon the formation of specific target/analyte binding pairs or hybridization include a reporter system that provides a detectable signal indicative of the formation of a specific binding pair. The reporter system may be a label that comprises a fluorescent material, a radioactive material, any signaling moiety or material that is further reactive with another species to form a colored complex or some other such detectable reaction product. Accordingly, in one embodiment, a method as described herein is provided wherein said reporter system is capable of inducing a color reaction and/or capable of bio-, chemi- or photoluminescence. In the example with fluorescent labels, the background signals can be conveniently quantified by scanning the array with a confocal camera or with a CCD camera, as is well known in the art. In accordance with other examples, the detection may also be label-free. For example, the surface Plasmon resonance or microring methods have been shown for detecting the binding of analytes to probes or the changes of cell morphology or cell volume. See Jordan et al. (1997) Anal. Chem. 69: 4939-4947, Ferreira et al. (2009) J. AM. CHEM. SOC. 131:436-437 and Peterson et al. (2009) BMC Cell Biology 10:16.

Molecules or compounds may be immobilized either covalently (e.g., utilizing single reactive thiol groups of cysteine residues,) or non-covalently but specifically (e.g., via immobilized antibodies, the biotin/streptavidin system, and the like) on the substrate, by any method known in the art. When covalent immobilization is contemplated, the substrate should be polyfunctional or be capable of being polyfunctionalized or activated with reactive groups capable of forming a covalent bond with the target to be immobilized (e.g. carboxylic acids, aldehydes, amino groups, cyano groups, ethylenic groups, hydroxyl groups, mercapto groups and the like).

In the preparation for immobilization to the arrays of the present invention, fusion proteins may be expressed from the recombinant DNA either in vivo or in vitro. Expression in vivo is in either bacteria (Esherichia coli), lower eukaryotes (Saccharomyces cerevisiae, Saccharomyces pombe, Pichia pastoris) or high eukaryotes (bacculo-infected insect cells, insect cells, mammalian cells), or in vitro (Esherichia coli lysates, wheat germ extracts, reticulocyte lysates). Proteins are purified by affinity chromatography using commercially available resins. DNA sequences encoding amino acid affinity tags or adaptor proteins may be engineered into the expression vectors such that the genes of interest can be cloned in frame either 5′ or 3′ of the DNA sequence encoding the affinity tag and adaptor protein.

In a further embodiment of the present invention, a method of preparing a substrate for use in a high throughput microarray is provided. The method comprises covering the surface of substrate with a coating material comprising at least one of commercially available photoresist films selected from the group consisting of NANO™ SU-8 2-15, NANO™ SU-8 50-100, NANO™ SU-8 2000 series photoresist, NANO™ SU-8 3000 series photoresist and KMPR® 1000 series photoresist films and patterning the coating material, wherein the patterning defining a plurality of microwells arranged in spatially discrete regions on the surface. This ensures that each sample applied or printed on the surface stays within the individual well even if the substrate is immersed in the cell culture medium. Accordingly, this design prevents the sample from being contaminated by adjacent cell clusters. The substrate may also include a plurality of microcolumns arranged in spatially discrete regions on the surface such that the reagent or biomolecule may be dispensed from the microcolumns into the sample. And a high throughput microarray system may be manufactured from such design.

The microarray chip of the present invention is particularly well-suited for use on high-throughput drug screening. In some embodiments, the drug screening method includes preparing a microarray chip having a plurality of microwells defined on a substrate, wherein the microwells comprises microwells in at least one of commercially available photoresist material (e.g., NANO™ SU-8 2-15, NANO™ SU-8 50-100, NANO™ SU-8 2000 series photoresist, NANO™ SU-8 3000 series photoresist and KMPR® 1000 series photoresist films), culturing a population of target cells in the microwells, dispensing a candidate drug into the microwells, and detecting any binding of the candidate drug to the target cell and any phenotypic change resulting from binding of the candidate drug to the target cells. As one example, to test the specificity of a drug candidate, its interaction with multiple members of a protein family may be determined. Members of the protein family may be separately immobilized in the microwells. The drug candidate's ability to interfere with protein activity, such as binding, catalytic conversion, or translocation of a ligand through a lipid bilayer, may then be determined.

To test a drug candidate's ability to interfere with a drug binding event, the drug candidate and a known ligand of a member of the protein family that is labeled by a chemically-conjugated fluorescent moiety may be delivered in a sample into each microwell. In accordance with one example, the drug or ligand may be delivered to the sample using the microcolumns or similar structures on the array chip. Specifically, the microcolumns of the array chip are first coated with the drug or ligand. The microcolumns are then inserted into the microwells holding or containing the sample. After a short incubation period, the microwells are washed to remove unbound drug and ligand. The amount of fluorescent ligand remaining in each of the microwells may be detected by using a fluorescent detector/quantifier with optical access to the microwells, either through a transparent or translucent substrate.

To test a drug candidate's ability to interfere with a catalytic conversion of a ligand by an enzyme, a drug candidate and ligand are delivered via the microcolumns into the microwell in a sample and changes in the chromogenic or fluorescent properties can be detected by using optical detector/quantifier with optical access to the microwell, either through a transparent or translucent substrate. To test a drug candidate's ability to interfere with the translocation of a ligand through a lipid bilayer, a drug candidate and ligand are delivered using the microcolumns or other similar dispensing apparatus to a sample in each microwell. After a short incubation period the microwells are washed to remove unbound ligand, and the ligand accumulated between lipid bilayer and the array is determined by measuring changes in fluorescence, absorption, or electrical charge.

Other uses of the microarray of the present invention include medical diagnostic and biosensors. In each case a plurality of biological moieties or drug candidates or analytes may be screened in parallel. Possible interactions that the present invention may be used to detect include but are not limited to antibody/antigen, antibody/hapten, enzyme/substrate, carrier protein/substrate, lectin/carbohydrate, receptor/hormone, receptor/effector, protein/DNA, protein/RNA, complementary strands of nucleic acid, repressor/inducer, and the like.

In accordance with one other embodiment, the invention provides a microarray chip which includes a quartz substrate and a patterned photoresist with a plurality of microwells formed on the quartz substrate, wherein the photoresist comprises at least one of commercially available photoresist film such as NANO™ SU-8 2-15, NANO™ SU-8 50-100, NANO™ SU-8 2000 series photoresist, NANO™ SU-8 3000 series photoresist and KMPR® 1000 series photoresist films.

According to yet another embodiment, the present invention provides a microarray chip which includes a glass substrate and a patterned photoresist with a plurality of microwells on the glass substrate, wherein the photoresist comprises at least one of commercially available photoresist film, such as NANO™ SU-8 3000 series photoresist and KMPR® 1000 series photoresist films.

According to one other embodiment, the present invention provides a drug array chip which includes a substrate and a patterned photoresist with a plurality of microcolumns on the substrate, wherein the photoresist comprises at least one of commercially available photoresist film, such as NANO™ SU-8 2-15, NANO™ SU-8 50-100, NANO™ SU-8 2000 series photoresist, NANO™ SU-8 3000 series photoresist and KMPR® 1000 series photoresist films.

The present invention generally provides a microarray system comprising a substrate covered with a commercially available photoresist material (e.g., NANO™ SU-8 2-15, NANO™ SU-8 50-100, NANO™ SU-8 2000 series photoresist, NANO™ SU-8 3000 series photoresist and KMPR® 1000 series photoresist films) that is patterned into a plurality of microstructures (e.g., microwells, microcolumns or a combination thereof). The substrate may include two surfaces each having desired microstructures thereon depending on specific needs. And one surface of the substrate having the microcolumns disposed thereon may be used with another substrate having microwells thereon. The microarray system is applicable to analysis of samples in fields of biology, biochemistry, physiology, pharmacology and immunology.

Unless defined otherwise, all technical and scientific terms used herein have the same meaning as commonly understood to one of ordinary skill in the art to which this invention pertains. In this application, certain terms are used frequently, which shall have the meanings as set forth in the specification. It must be noted that as used herein and in the appended claims, the singular forms “a,” “an,” and “the” include plural referents unless the context clearly dictates otherwise.

It should be noted that the terminology used herein is not intended to be limiting, since the scope of the present invention will be limited only by the appended claims.

Accordingly, definitions should not be understood to limit the scope of the invention. Rather, they should be used to interpret the language of the description and, where appropriate the language of the claims. These terms may also be understood more fully in the context of the description of the invention. If a term is included in the description or the claim that is not further defined within the present description, or can not be interpreted based on its context, then it should be construed to have the same meaning as it is understood by those skilled in the art.

The invention will now be described in further detail with reference to the following specific, non-limiting examples.

### Example 1

### Array Chip Fabrication Using a Quartz Wafer

Quartz wafer was cleaned according to a Piranha Clean procedure as suggested (http://engineering.tufts.edu/microfab/index_files/SOP/PiranhaClean_SOP.pdf), and dried prior to coating with the photoresist material. The quartz wafer was then placed on a TEFLON™ carrier and submerged in a bath of 96% H₂SO₄:30% H₂O₂ solution (1:1) for 10-20 minutes to remove all organics. Next, the quartz wafer was removed from the bath and rinsed in deionized (DI) water for 15 minute. After the Piranha clean, the quartz wafer was blown dry with nitrogen or dried in an oven at 120° C. or on a hotplate at 150° C. and placed in a carrier box until ready for coating.

Commercially available photoresist material such as SU-8 100 film (MicroChem, Newton Mass.) having a thickness of about of 100 μm was spin-coated on the quartz wafer according to the coating conditions described as follow. During a spread cycle the wafer was ramped to 500 rpm at an acceleration of 100 rpm/second and held for 10 seconds to allow the resist covering the entire surface of wafer. At a spin cycle, the wafer was ramped to 3000 rpm at an acceleration of 300 rpm/second and held for a total of 30 seconds. Next, the wafer was soft baked on a hot plate at 65° C. for 10 minutes followed by 95° C. for 30 minutes. The microwells were defined by a standard photolithography process using an UV light source. The EVG 620 Top Side Mask Aligner was used to expose the resist at 650 mJ/cm² and UV below 350 nm was eliminated.

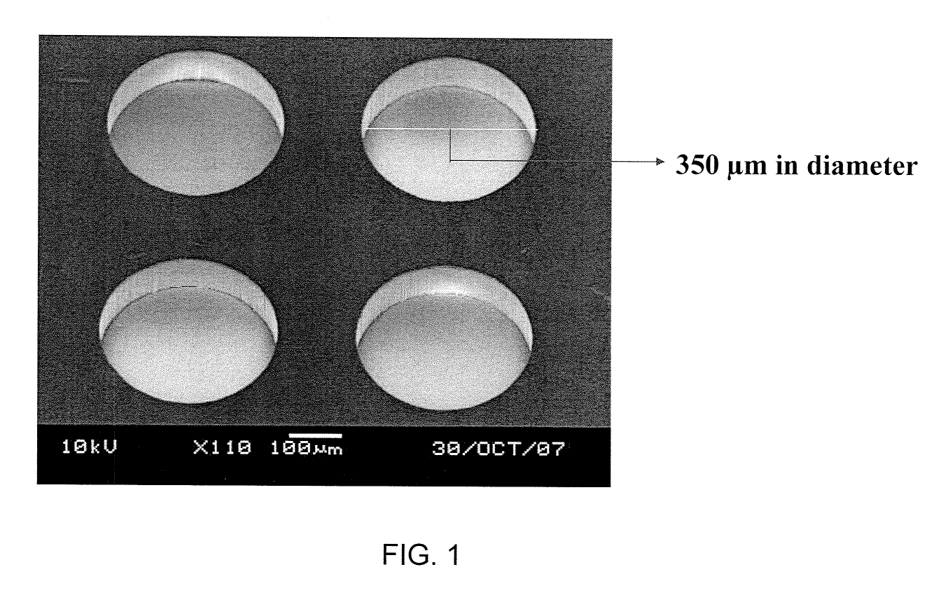

Following the exposure process, the SU-8 100 film was then baked on a hot plate at 65° C. for 3 minutes and baked at 95° C. for further 10 minutes. The patterns were developed with SU-8 developer (MicroChem, Newton Mass.) for 10 minutes. The SU-8 100 film was rinsed with isopropyl alcohol after development and air-dried with nitrogen. Next, the SU-8 100 film was subjected to hard baking on a conventional oven at 150° C. for 15 min. As a result, a microarray chip having a plurality of wells (each having a diameter of about 500 μm) defined on the quartz wafer was formed. And a microscopic image of the microarray chip was taken by a scanning electron microscopy and shown in FIG. 1.

### Example 2

### Array Chip Fabrication Using a Glass Wafer

Glass wafer was cleaned by a Piranha clean procedure as described above and dried prior to coating with the photoresist. The glass wafer was then placed on a TEFLON™ carrier and submerged in a bath of H₂O:H₂O₂:NH₄OH solution (5:1:1) for 10 minutes. Next, the glass wafer was removed from the bath and rinsed in deionized (DI) water for 1 minute. The glass wafer was further submerged in a bath of H₂O:HF solution (50:1) for 15 seconds and rinsed in the DI water for 1 minute. The glass wafer was submerged in a bath of H₂O:H₂O₂:HCl solution (6:1:1) for 10 minutes and rinsed in DI water for 1 minute. After the RCA clean, the glass wafer was blown dry with nitrogen and placed in a carrier box until ready for coating.

Commercially available photoresist such as SU-8 3050 film (MicroChem, Newton Mass.) having a thickness of about 100 μm was spin-coated on a glass wafer according to the coating conditions described as follow. During a spread cycle the wafer was ramped to 500 rpm at an acceleration of 100 rpm/second and held for 10 seconds to allow the resist covering the entire surface of wafer. At a spin cycle, the wafer was ramped to 1000 rpm at an acceleration of 300 rpm/second and held for a total of 30 seconds. Next, the wafer was soft baked on a hot plate at 95° C. for 45 minutes. The microwells were defined by a standard photolithography process using an UV light source. The EVG 620 Top Side Mask Aligner was used to expose the resist at 375 mJ/cm² and UV below 350 nm was eliminated.

Following the exposure process, the SU-8 3050 film was then baked on a hot plate at 65° C. for 1 minute and baked at 95° C. for further 5 minutes. The patterns were developed with SU-8 developer (MicroChem, Newton Mass.) for 15 minutes. The SU-8 3050 film was rinsed with isopropyl alcohol after development and air-dried with nitrogen. Next, the SU-8 3050 film was subjected to hard baking on a conventional oven at 150° C. for 15 min. As a result, a microarray chip having a plurality of wells (each having a diameter of about 500 μm) defined on the glass wafer was formed.

### Example 3

### Array Chip Fabrication Using a Silicon Wafer

Silicon wafer was cleaned by a Piranha clean procedure as described above and dried prior to coating with the photoresist. The silicon wafer was then placed on a TEFLON™ carrier and submerged in a bath of H₂O:H₂O₂:NH₄OH solution (5:1:1) for 10 minutes. Next, the silicon wafer was removed from the bath and rinsed in deionized (DI) water for 1 minute. The silicon wafer was further submerged in a bath of H₂O:HF solution (50:1) for 15 seconds and rinsed in the DI water for 1 minute. The silicon wafer was submerged in a bath of H₂O:H₂O₂:HCl solution (6:1:1) for 10 minutes and rinsed in DI water for 1 minute. After the Piranha clean, the silicon wafer was blown dry with nitrogen and placed in a carrier box until ready for coating.

Commercially available negative tone photoresist such as SU-8 50 film (MicroChem, Newton Mass.) having a thickness of about 50 μm was spin-coated on a glass wafer according to the coating conditions described as follow. During a spread cycle the wafer was ramped to 500 rpm at an acceleration of 100 rpm/second and held for 10 seconds to allow the resist covering the entire surface of wafer. At a spin cycle, the wafer was ramped to 2000 rpm at an acceleration of 300 rpm/second and held for a total of 30 seconds. Next, the wafer was soft baked on a hot plate at 65° C. for 6 minutes followed by 95° C. for 20 minutes. The microcolumns were defined by a standard photolithography process using an UV light source. The EVG 620 Top Side Mask Aligner was used to expose the resist at 375 mJ/cm² and UV below 350 nm was eliminated.

Following the exposure process, the SU-8 50 film was then baked on a hot plate at 65° C. for 1 minute and baked at 95° C. for further 5 minutes. The patterns were developed with SU-8 50 developer (MicroChem, Newton Mass.) for 6 minutes. The SU-8 50 film was rinsed with isopropyl alcohol after development and air-dried with nitrogen. Next, the SU-8 50 film was subjected to hard baking on a conventional oven at 150° C. for 15 min. As a result, a drug array chip having a plurality of columns (each having a diameter of about 350 μm) defined on the silicon wafer was formed.

### Example 4

### Adhesion Test

It has been reported that SU-8 100 photoresist was used to fabricate microwells on the glass substrate of the microarray chip. See Chin et al. (2004) Biotechnology and Bioengineering 88 (3): 399-415. However, it was later demonstrated that NANO™ SU-8 2-25, NANO™ SU-8 50-100 photoresist film as well as SU-8 2000 series photoresist film, such as NANO™ SU-8 2000.5-2015, NANO™ SU-8 2025-2075 or NANO™ SU-8 2100-2150 film provided very weak adhesion with the glass substrate. As a result, the photoresist film might peel off from the surface of glass substrate when the microarray chip was stocked in the air at room temperature or immersed in the culture medium during the cell culture experiment.

A group of photoresist films, such as SU-8 100, SU-8 2050 and SU-8 3050, KMPR 1050 films were tested for their adhesion against a set of available substrates, such as silicon, quartz and glass substrates using an adhesion tester (ROMULUS III universal tester) at National Nano Device Laboratory (NDL).

Firstly, aluminum nails were affixed on a tested film containing the photoresist film and the substrate. The tested film was then baked on a hot plate at 150° C. for an hour so that the aluminum nails adhered to the tested film. The tested film was cooled down and mounted on a clamping device. A breaking point platform having a force system and force transducer was included in the adhesion tester to provide a 0 kg to 100 kg downward pulling force. The adhesion tester was semi-automated by a computer workstation to measure the maximal adhesion of the film. Any cracking on the tested film was checked to determine if the testing results were positive. Once the testing showed positive results, they were recorded listed in Table 1 below. Otherwise, the testing was repeated using another tested film.

TABLE 1

| | Silicon (kg/cm²) | Quartz (kg/cm²) | Glass (kg/cm²) |
|---|---|---|---|
| SU-8 100 | 604 | 289 | <4.39 |
| SU-8 2050 | 570 | 194 | Not detected |
| SU-8 3050 | 130 | 298 | <4.39 |
| KMPR 1050 | 69 | 495 | 46 |

From Table 1, it was evident that the glass substrate does not have a good adhesion with most of the photoresisted film tested except KMPR 1050. And once the SU-8 2050 film was manufactured, it was found to peel off from the glass even before the adhesion test was conducted in the NDL. On the other hand, silicon or quartz substrate has a good adhesion with most of the photoresist films tested.

Cell Culture

The photoresist film coated over the surface of glass or quartz wafer were defined and patterned by photolithpgraphic process to form a plurality of microwells on the wafer. The wafer was diced using dicing saw (precision dicing system) into chips with standard microscope slide size (75 mm×25 mm). After a storage period of approximately 2 weeks, the fabricated chips were sterilized and placed in culture dishes, each having a diameter of 10 cm. Each culture dish was then dispensed with MEM culture medium and incubated at 37° C. The fabricated chip in the culture dish was observed 2 days after the incubation by naked eyes. The results are listed in Table 2 below.

TABLE 2

| | Silicon | Quartz | Glass |
|---|---|---|---|
| SU-8 100 | normal | normal | Film peel off |
| SU-8 2050 | normal | normal | Film peel off |
| SU-8 3050 | normal | normal | normal |
| KMPR 1050 | normal | normal | normal |

From Tables 1 and 2, it was found that quartz substrate has a good adhesion to all the photoresist films tested and provides a stable environment for the cell culture in the microarray chip. On the other hand, the glass substrate has a poor adhesion with both SU-8 100 and SU-8 2050 films. According to Table 1, SU-8 100 film has a similar adhesion to the glass as SU-8 3050 film in the physical adhesion test. However, the microwells constructed with SU-8 100 film were found to peel off from the glass surface during cell culture, leaving only the microwells constructed with SU-8 3050 intact and adhered to the glass for long term maintenance of cell culture in the microarray chip.

### Example 5

### Microarray Analysis of Cells Transfected with siRNA

Human cervical cancer cell line (HeLa cells) and Human embryonic kidney cell line (293T cells) commonly used for transfection assay were selected for the transfection experiment. HeLa cells were grown in Minimum Essential Medium with 10% FCS and 100 units/ml penicillin/streptomycin at 37° C. in 5% CO₂ incubator. And 293T cells were grown in Dulbecco's Modified Eagle's Medium with 10% FCS and 100 units/ml penicillin/streptomycin at 37° C. in 5% CO₂ incubator.

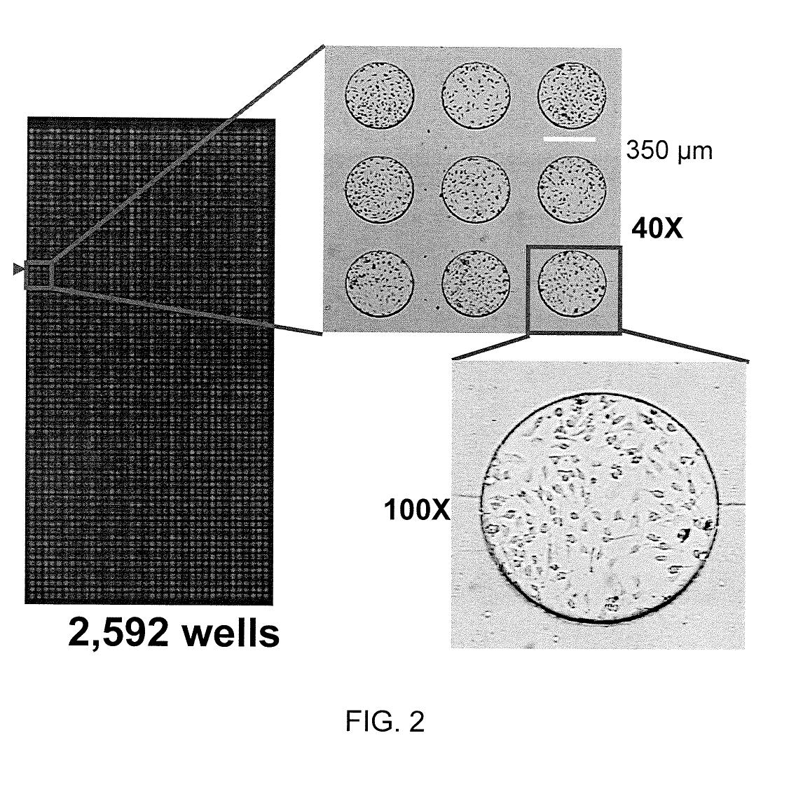

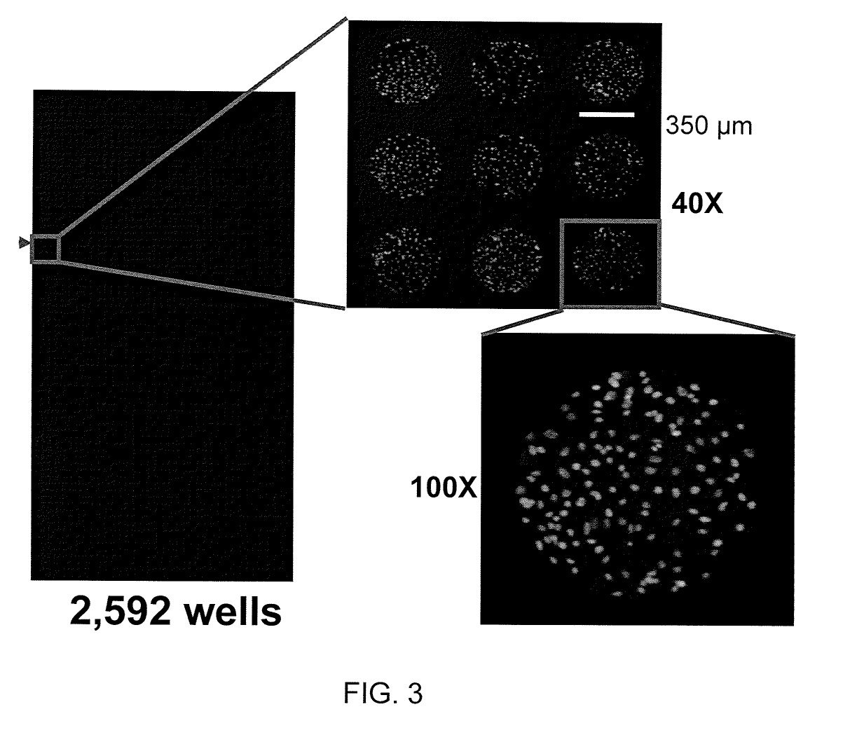

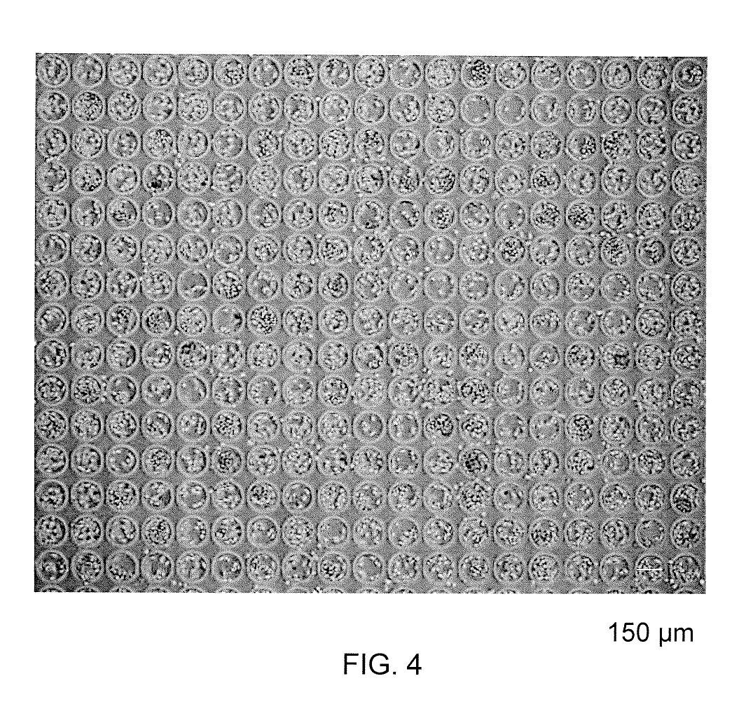

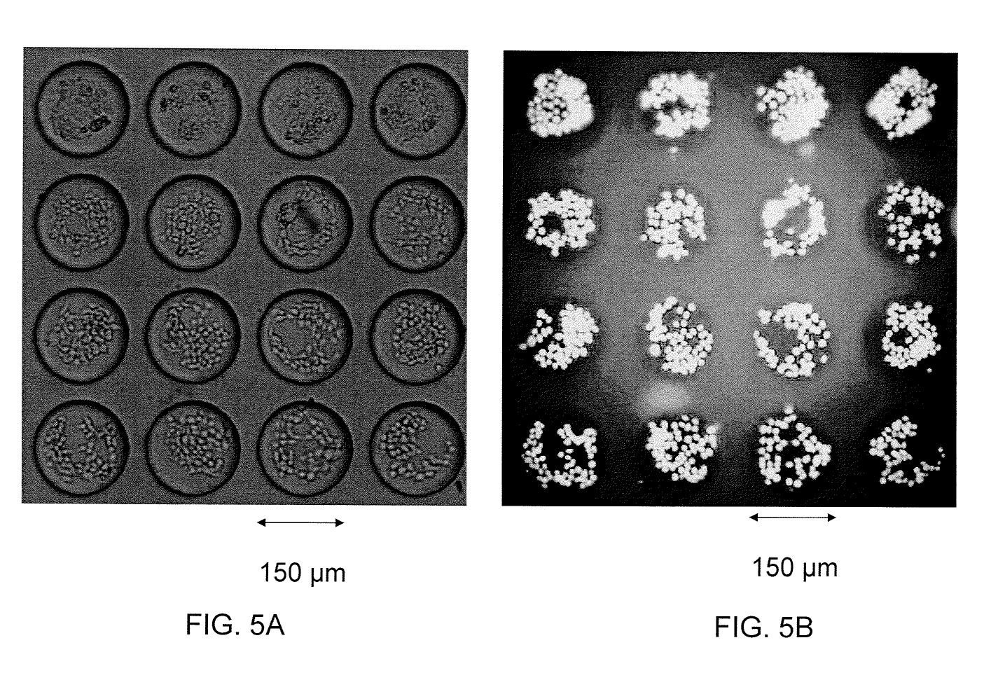

The HeLa cells were collected as a cell suspension and delivered to each microwell on either a 2,592-well or 40,098-wells microarray chip fabricated according to Example 1 or 2. The living HeLa cells in the microwells were observed under phase contrast microscopy and microscopic images were captured and shown in FIGS. 2 and 4. Similarly, 293T cells were collected as a cell suspension and delivered to each microwell on a 40,098-wells microarray chip. The living 293T cells in the microwells were observed under phase contrast microscopy and a microscopic image was captured and shown in FIG. 5A. The HeLa cells and 293T cells were also labeled with fluorescent cell markers to enhance cell detection using fluorescent confocal microscopes. The images were captured and shown in FIGS. 3 and 5B respectively.

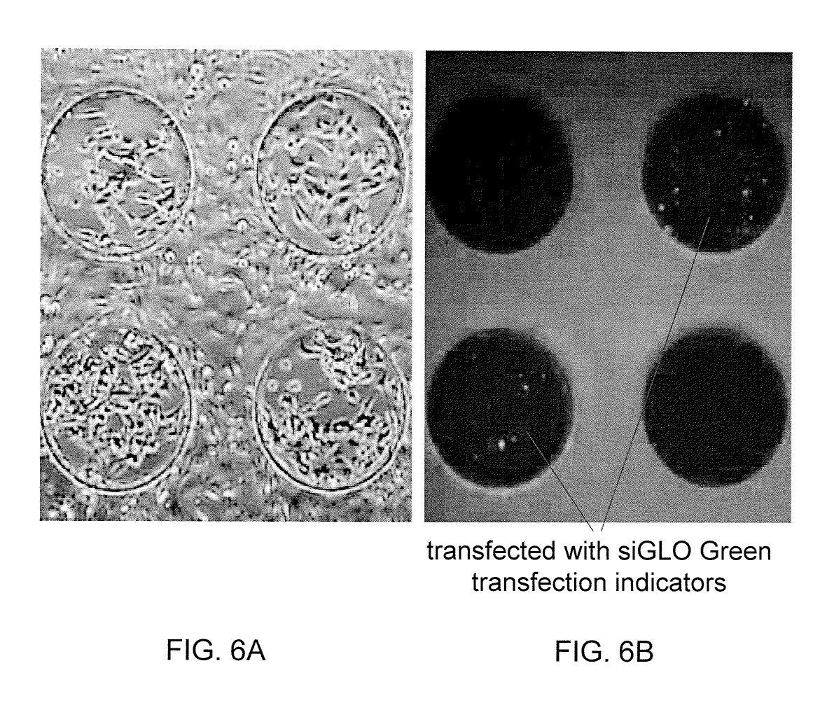

The HeLa cells were transfected with siGLO green transfection indicator according to the manufacturer's instruction (Dharmacon Inc.). Fluorescent RNA duplexes were spotted 0.001 pmole/well into the 2,592-well microarray chip prepared according to either Example 1 or 2. Next, 1,575 μL of rehydration solution (25 μL of DharmaFECT and 1,550 μL of RNase-free water) was dispensed onto chip. The DharmaFECT transfection reagent was allowed to complex with RNA duplexes at room temperature for 20 minutes. The chip was transferred into a culture dish and 12 mL of cell suspension (6.25×10⁵ cells per mL) was added to the culture dish. Referring to both FIGS. 6A and 6B, the cells were incubated at 37° C. in the presence of 5% CO₂ and assayed at 48 h posttransfection. As shown in FIG. 6B, the HeLa cells transfected with the siGLO green transfection indicator were observed under the fluorescent microscope.

### Example 6

### Subcellular Localization of NF-κB Using Microarray Analysis

HeLa cells were seeded 60×10⁴ cells/well in microwells (each having a diameter of about 500 μm and a depth of about 100 μm) of a 2,666-well cell array prepared in accordance with either example 1 or 2. The drug array prepared according to example 3 had a plurality of microcolumns (each having a diameter of about 350 μm and a height of about 50 μm) coated with alginate to absorb/retain drugs for the release onto cells in the microwells and pyrrolidine dithiocarbamate (PDTC) which is the inhibitor for NF-κB activation. Specifically, PDTC at different dilutions were mixed with a diluted alginate solution, and the mixture was applied as PDTC spots using a pipetman to different areas on the microcolumns of the drug array. Phosphoinositide 3-kinase inhibitor (LY294002) was applied as LY294002 spots from other rows of microcolumns to the cells in the negative control group alongside the PDTC-treated group and non-treated group. The drug array with the microcolumns was lowered with each PDTC spot or LY294002 spot facing the opening of each corresponding microwell and inserted into the microwells. The entire assembly of drug array-cell array was placed in cell culture incubator at 37° C. for 4 hours until the PDTC or LY294002 was released from the microcolumn. The drug array was removed, and the cell array was rinsed for 3 times, and incubated cells with TNF-α for 30 minutes. Immunoassay was carried out to determine subcellular localization of NF-κB.

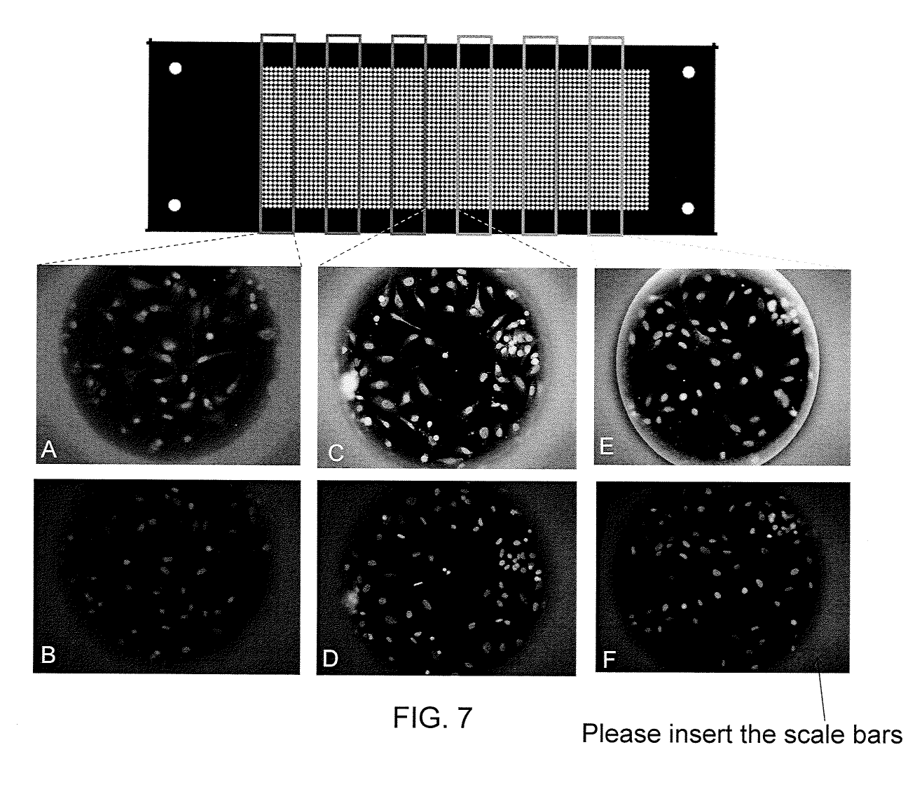

In accordance with the experiment protocols for DAPI staining/staining for NF-κB, the cells on cell array was washed with 10 ml PBS in 10 cm dish and then the PBS was removed. Next, the cells were fixed with 3.7% paraformaldehyde 2 ml at room temperature for 20 minutes. The cell array was aspirated with paraformaldehyde and then washed twice: once with 10 ml PBS (0 min) and once with 10 ml PBS (more than 5 minutes). The cells were blocked with 1% Bovine Serum Albumin (BSA) 10 ml at room temperature for 30 minutes. The cells were aspirated with BSA and then applied with the primary antibody (NF-κB antibody) and incubated at room temperature for 1 hour. The cells were washed three times with phosphate buffer saline (PBS) 10 ml for 5 min each and then incubated with the secondary antibody conjugated with Tetramethyl Rhodamine Iso-Thiocyanate (TRITC) and 4′-6-Diamidino-2-phenylindole (DAPI) at room temperature for 1 hour in the dark. The cells were washed three times with PBS 10 ml for 10 minutes each. The subcellular localization of NF-κB in the cells was detected by observing the TRITC and DAPI staining using Fluorescent microscopy and the results were illustrated in FIGS. 7A through to 7F. Referring to FIG. 7A, pre-treatment of 0.1 mM PDTC has dramatically reduced the number of NF-κB induced by Tumor Necrosis Factor alpha (TNF-α) in the group of PDTC-treated HeLa cells (indicated by a red square) as compared to the non-treated group of HeLa cells (indicated by green dotted lines) shown in FIG. 7C, whereas FIGS. 7B and 7D show the corresponding DAPI staining for their cell nuclei. Also referring to FIG. 7E, the negative group of the HeLa cells (indicated by a blue square) pre-treated with 0.2 mM LY294002 showed very little or almost no staining of NF-κB in the cells whose locations were confirmed by determining their nuclear locations in FIG. 7F.

It will be appreciated by those skilled in the art that changes could be made to the embodiments described above without departing from the broad inventive concept thereof. It is understood, therefore, that this invention is not limited to the particular embodiments disclosed, but it is intended to cover modifications within the spirit and scope of the present invention as defined by the appended claims.

That which is claimed:

1. A microarray chip comprising:
(a) a substrate; and
(b) a coating material covering the substrate, wherein the coating material comprises at least one commercially available photoresist material and is patterned to comprise a plurality of microstructures on the substrate.

2. The microarray chip of claim 1, wherein the substrate is quartz.

3. The microarray chip of claim 1, wherein the substrate is glass.

4. The microarray chip of claim 1, wherein the at least one commercially available photoresist material comprises NANO™ SU-8 2-15, NANO™ SU-8 50-100, NANO™ SU-8 2000 series photoresist, NANO™ SU-8 3000 series photoresist and KMPR® 1000 series photoresist films.

5. The microarray chip of claim 1, wherein the microstructures are microwells.

6. The microarray chip of claim 1, wherein the microstructures are microcolumns.

7. The microarray chip of claim 6, wherein the microcolumns further comprises micromachined microcolumns.

8. The microarray chip of claim 6, wherein the microcolumns further comprises microelectromechanical systems (MEMS) fabricated microcolumns.

9. The microarray chip of claim 1, wherein the microstructures include a combination of microwells on one surface of the substrate and microcolumns on another surface of the substrate.

10. A platform for analyzing binding of a probe to a sample comprising:
(a) an array chip comprising at least one substrate and a coating material covering the substrate, wherein the coating material comprises at least one commercially available photoresist material and is patterned to comprise a plurality of microwells;
(b) a means for applying the probe to the sample in the microwells; and
(c) a means for detecting any binding of the probe and the sample and any phenotypic change resulting from binding of the probe and the sample.

11. The platform of claim 10, wherein the at least one commercially available photoresist material comprises NANO™ SU-8 2-15, NANO™ SU-8 50-100, NANO™ SU-8 2000 series photoresist, NANO™ SU-8 3000 series photoresist and KMPR® 1000 series photoresist films.

12. The platform of claim 10, wherein the substrate is quartz.

13. The platform of claim 10, wherein the substrate is glass.

14. The platform of claim 10, wherein the means for applying the probe comprises a plurality of microcolumns.

15. A drug screening method comprising:
(a) providing a microarray chip, wherein the microarray chip comprises a substrate and a coating material covering the substrate, wherein the coating material comprises at least one commercially available photoresist material and is patterned to comprise a plurality of microwells;
(b) culturing a target cell in the microwells;
(c) dispensing a candidate drug into the microwells; and
(d) detecting any binding of the candidate drug to the target cell and any phenotypic change resulting from binding of the candidate drug and the target cells.

16. The method of claim 15, wherein the at least one commercially available photoresist material comprises NANO™ SU-8 2-15, NANO™ SU-8 50-100, NANO™ SU-8 2000 series photoresist, NANO™ SU-8 3000 series photoresist and KMPR® 1000 series photoresist films.

17. The method of claim 15, wherein the candidate drug is dispensed from a plurality of microcolumns on the substrate.

18. A method for analyzing binding of a probe to a sample comprising:
(a) providing a microarray chip, wherein the microarray chip comprises a substrate and a coating material covering the substrate, wherein the coating material comprises at least one commercially available photoresist material and is patterned to comprise a plurality of microwells;
(b) applying the probe to the sample in the microwells; and
(c) detecting any binding of the probe to the sample and any phenotypic change resulting from binding of the probe to the sample.

19. The method of claim 18, wherein the at least one commercially available photoresist material comprises NANO™ SU-8 2-15, NANO™ SU-8 50-100, NANO™ SU-8 2000 series photoresist, NANO™ SU-8 3000 series photoresist and KMPR® 1000 series photoresist films.

20. The method of claim 18, wherein the probe is applied from a plurality of microcolumns on one surface of the substrate.
